(19) United States
(12) Patent Application Publication
(10) Pub. No.: US 2005/0034099 A1
(43) Pub. Date: Feb. 10, 2005

(54) Method of developing software programs for resource constrained mobile computing devices

(76) Inventor: David Spooner, Middlesex (GB)

Correspondence Address: Richard C Woodbridge;Synnestvedt Lechner & Woodbridge, P O Box 592, Princeton, NJ, 08542-0592, US

(21) Appl. No.: 10/493,339

(22) PCT Filed: Oct. 22, 2002
(86) PCT No.: PCT/GB02/04755

(30) Foreign Application Priority Data
Oct. 22, 2001 (GB) 0125214.7

(51) Int. Cl. G06F 9/44

(52) U.S. Cl. 717/104

(57) ABSTRACT

A method of developing a software program for resource constrained mobile computing devices comprises the step of using a library of three mandatory types of code which enable a system to be modelled, the three types of code being: (a) a first re-useable object which defines the transmission of raw binary data between a writer end and a reader end; (b) a second re-useable object which defines ordered name/value pairs and (c) an abstract API definition that defines how to write, create, call or use a task which handles the first and/or second objects. This very high level abstraction has been found, surprisingly, to apply to virtually all systems which have been analysed by the applicant. Hence, the present invention allows a small (deliberately restricted), core library of “primitives” to be built once and re-used very many times as building blocks by different applications. Re-use of code defining high level abstractions considerably reduces overall code size (a major technical advantage for mobile computing devices) and speeds up developing new programs (major technical advantage in the rapidly moving world of program development for mobile computing devices).

### FIELD OF THE INVENTION

This invention relates to a method of developing software programs for resource constrained mobile computing devices, such as personal organisers, mobile telephones and communicators.

### DESCRIPTION OF THE PRIOR ART

Mobile computing devices impose severe design constraints on the program developer, requiring programs to (a) occupy the minimum of size to reduce expensive ROM occupancy and (b) to execute rapidly to minimise power consumption. Conventionally, the operating system running on the device will mandate various code writing techniques designed to minimise application code size (see for example the Descriptors technique described in PCT/GB98/01717, designed to optimise the Symbian OS for mobile computing devices). However, program developers working in this area still typically apply a development methodology better suited for writing programs on PC and other devices that do not suffer from the same constraints as mobile computing devices.

For example, if a programmer is writing a web server for a mobile computing device, then he will typically write (a) code to parse the HTTP request and (b) additional code to fetch/produce the HTML content to return as a HTTP response. If another programmer is writing a WAP or OBEX server to serve WAP or OBEX content then he will write (a) code to parse the WAP or OBEX request and (b) additional code to fetch/produce the content to return. Hence often different code will be written to perform the data request and fetch functions because the request formats and data formats differ between web, WAP, OBEX.

Whilst libraries of code which can be shared by different applications might theoretically address unnecessary duplication, the practical reality is that current program development methodologies would not achieve this because they would not enable a developer to see clearly what a web server and an OBEX server would have in common. In other words, current software development methodologies fail to impose a deep (i.e. simplest) enough level of abstraction that enables developers to see what is common between different processes and hence write code that can be re-used across these processes.

Computer science has in the past offered various deep abstractions of software processes; perhaps the most famous of these is the Turing machine, which comprises a read/write head scanning an infinite tape divided into sections labelled with a ‘0’ or ‘1’. Whilst a milestone in the history of computer science and the philosophy of mind, Turing machines are of little practical help in designing programs for real world devices.

The technical problem this invention deals with is how to devise a new software development methodology that allows programs to be rapidly and efficiently developed for resource constrained mobile computing devices.

### SUMMARY OF THE PRESENT INVENTION

In a first aspect of the present invention, a method of developing a software program for resource constrained mobile computing devices comprises the step of using a library of three types of code which enable a system to be modelled, the three types of code being:
(a) a first re-useable object which defines the transmission of raw binary data between a writer end and a reader end;
(b) a second re-useable object which defines ordered name/value pairs; and
(c) an abstract API definition that defines how to write, create, call or use a task which handles the first and/or second objects;
   characterised in that these three types of code form a restricted set of mandatory primitives that are re-used by one or more applications running on the device.

The terms of art used in this claim should be construed according to their normal meaning. An object is any variable which can be handled as a discrete entity. A task (which is a type of ‘module’ or component that conforms to the API definition) is a self-contained, named block of executable code, such as a DLL, or a script; its role is to handle the first and second objects.

The very high level abstraction on which the present invention is based has been found, surprisingly, to apply to virtually all systems which have been analysed by the applicant. Hence, the present invention allows a small (deliberately restricted), core library of basic building blocks or “primitives” to be built once, loaded onto a device, and re-used very many times in different applications running on the device. Re-use of code defining high level abstractions considerably reduces overall code size (a major technical advantage for mobile computing devices) and speeds up developing new programs (a major technical advantage in the rapidly moving world of program development for mobile computing devices). The application developer can then concentrate on writing the additional code—‘glue’ logic—(often small compared to the original overall problem) to deliver the finished application: the ‘glue’ logic or code sits over the primitives and represents a level which makes the code specific to a given system or purpose (although it may itself be reusable). This makes application development fast, efficient and robust.

Overall, by enforcing the unusually high level of abstraction associated with the three primitives, it has been found in practice that very different systems (and of arbitrary complexity) can be built using a small number of the above-defined primitives. These primitives occupy very little code space. This means that the common primitives (i.e. common to several applications, such as a web server, WAP server and OBEX server) can be burnt to ROM. Further, they can be invoked in a resource efficient manner.

No other software development methodology, computing environment, operating system, or language, known to the applicants, imposes the same rigorous and universal high level abstraction approach. The above defined three mandatory code types have been found to be optimal; adding further code types and specifying that their use is mandatory will generally be sub-optimal, although within the scope of the present invention since based upon the foundation of the three mandatory code types.

A commercial implementation of the present invention is available from Intuwave Limited of London, United Kingdom. It is called mStream. In mStream, the first object is called a ‘pipe’. The second object is called a ‘bundle’. mStream includes a set of libraries that can be used to implement ‘tasks’ (also known as ‘pipe processors’) which conform to the abstract API definitions that define how to write, create, call or use a task which handles pipes and/or bundles.

Using mStream, a web server called m-Surf has been built. In m-Surf, the first primitive object (a pipe) defines how unparsed content data is tunnelled through the system route A to F in FIG. 1 (each of A, B etc is a pipe; the collection of pipes and associated glue logic is a pipeline). The second primitive object or bundle defines how structured requests are passed through the system and the final API primitive defines how the tasks (and other non-task) modules are written and invoked.

The first glue code is a TCP listener 1 that converts between TCP/IP and the first object (‘Pipe A’). TCP listener 1 could be implemented as a task (glue logic is generally implemented as tasks, although they may also be conventional modules). Further glue code is implemented as a task IHttpSvr 2; this reads data from Pipe A, interprets that data as HTTP and outputs a second object—Request Bundle 3 representing the HTTP request, together with another pipe—Pipe B with additional decoded content inside it. Additional glue code LocalUrlResolver 4 takes Request Bundle 3 defining the HTTP request and Pipe B, and decides how to perform/service the request. This glue code LocalUrlResolver 4 returns a HTTP response as a Response Bundle 5, which is then passed back to IHttpSvr 2 which then encodes the HTTP response as data to return via another pipe, Pipe F to the first glue logic TCP listener 1, which then sends the data out on TCP. FIG. 1 also shows ‘other processes 6’ to indicate that in practice LocalUrlResolver 4 may be using other pipes, glue logic etc to perform its operation.

To modify this to an OBEX server, IHttpSvr 2 would process OBEX requests (hence it would be IOBEXSvr). (LocalUrlResolver 4 might be extended to accommodate any new request parameters. TCP listener 1 might be replaced by a component that could receive OBEX messages via infra-red or Bluetooth). However, the same system inter-connection structure is used since the pipeline concept is neutral as to the nature of data being requested. The end result is a modular system that can be readily altered to suit different requirements—just by altering perhaps a single item of glue logic (i.e. IHttpSvr 2) can an entirely new application be developed. Also, in practice, all components other than IHttpSvr 2, LocalUrlResolver 4 and possibly other processes 6 are burnt into ROM of the mobile computing device. The glue logic that has to be added in (and will run in RAM) is very code efficient—typically 100 KB for all of IHttpSvr 2, LocalUrlResolver 4 and possibly other processes 6 combined.

TcpListener 1 glue logic is inherently re-useable since it is in ROM. In principle, other glue logic can also go into ROM and be re-useable. For example, the entire FIG. 1 illustrated mSurf web server could be implemented in ROM. Then, an OBEX server could be built on top of this by simply supplying a IOBEXSvr component that could utilise the ROM based resources. This would be very code efficient (adding perhaps 30 KB) to RAM.

LocalUrlResolver 4 makes the decision as to which other processors 6 to call at run time; by adding new pipe processors 6 implemented as plug-ins to the existing pool of callable processors 6, functionality can be extended. As an example, the web server could initially be shipped with functionality defined in the other processors 6 that allows a user to browse contacts in an address book. A new pipe processor (forming part of the callable processors 6) allowing the user to browse photographs might then be defined and be made accessible to m-Surf. This new pipe processor could be downloadable after initial shipment (e.g. by infra-red, Bluetooth (RTM), GPRS etc.). This in practice would enable major system enhancements to be rolled out after initial device shipment and hence enable users to readily add new features and functions to their mobile computing devices.

The present invention also enables code efficient access control (i.e. controlling access to sensitive data) to be implemented. Conventionally, a secure application is allocated a secure area of memory; this prevents different applications from looking directly at the data controlled by the secure application. Instead, the secure application copies and sends out data that it wishes to share; this however leads to multiple copies of the same data. In an implementation of the present invention, it is a manager process that creates and owns pipes and bundles and starts and owns the tasks. It can, when dealing with sensitive data, pass to a requesting entity a small handle (typically 4 bytes in length) that points to the bundle or pipe end or blob or string that includes the sensitive data: an object can hence be exposed using a small handle. This avoid unnecessary data replication; also, transferring data handles is very fast because of their extremely small size. The requesting entity can then request to read only those data items from the bundle that it needs, rather than being given an entire bundle with data that it has no interest in.

Access control is provided for by the requesting client session being identified by a unique, communication session specific ID, generated by the device operating system (a feature within the Symbian OS, for example). The manager process then checks whether the requesting client session (as identified by the unique ID) has been granted the necessary read/write rights by the application that created (or otherwise controls) the primitive being manipulated/examined. Note that the manager offers no assistance to the granting client in choosing which peer clients to grant permissions to, it merely enforces the decision made by the grantor.

Further details of the invention are particularised in the appended claims.

In a second aspect of the invention, there is a mobile computing device when programmed with a program developed using the above inventive method.

In a third aspect, there is a software program developed using the above inventive method.

### BRIEF DESCRIPTION OF THE DRAWINGS

The present invention will be described with reference to the accompanying drawings, in which:

FIG. 1 is a schematic of an implementation of the present invention called mSurf;

FIG. 2 is a schematic of an implementation in Symbian Connect;

FIGS. 3-9 are schematics of tasks; and

FIGS. 10 and 11 are schematics of an implementation called mView.

### DETAILED DESCRIPTION

A commercial implementation of the present invention is available from Intuwave Limited of London, United Kingdom. It is called mStream. mStream has been implemented for the Symbian platform, a leading OS for mobile computing devices. A port to Microsoft Win CE has also been achieved. In mStream, the first object is called a ‘pipe’. The second object is called a ‘bundle’. mStream includes a set of libraries that can be used to implement ‘tasks’ (also known as ‘pipe processors’) which conform to the abstract API definitions that define how to write, create, call or use a task which handles pipes and/or bundles.

Pipes

Pipes are objects that define the transmission of raw binary data between 2 ends, preserving the order of that data. Pipes are hence the highest (i.e. most simple) level abstraction of a transmission medium; as such, they need know nothing about the data they pass, unlike request/response transmission systems such as FTP or SOAP.

Summary of Pipe Mandatory Properties:

Uni directional: pipes only transfer data in one direction. There is an explicit write end and a read end. Either of the two ends could be passed to a process or thread without also transferring the other end; this enables communication to or form a process or thread.
Inter-Process/Inter-Thread: the two ends can be in different processes or threads, enabling binary data communication between processes, and between threads.
Buffered: the pipe has a predefined capacity so that when data is written into the pipe it can absorb and retain that data until a reader reads it out. The buffered amount is fixed.
Binary (content/format unaware): pipes impose no requirement for data to conform to a predefined structure.
Infinite/Finite content length: pipes need not be finite (unlike some pipes—i.e. those that require a writer to define the data end point). They can be finite if needed, with an optional predefined expected content length. For example, you may know that you are reading a file of size x MB from a disc; then the pipe could be told to expect content of x MB and will close after that amount of data has passed (and will flag an error if closure is premature or excessive). Pipes may close so that the recipient can infer that all of the content has been sent.
   Bundles

Bundles are objects that define ordered name/value pairs. Bundles are hence the highest level of abstraction of structured content. A bundle can be thought of as a form with no pre-defined fields; the form is populated by inserting name/value pairs. A bundle can be passed around a pipe as a single object.

Summary of Mandatory Bundle Properties:

Contains Name/Value pairs: each value has an associated name, allowing that value to be obtained by specifying the name.
Names are sensitive; some languages (e.g. C++) require this. Case insensitivity is a special and non-mandatory feature.
Values include
   Strings (e.g. Unicode/UTF8): values can be added as UCS 2—a way of representing Unicode text strings—and retrieved as UTF8 (or vice versa)
   Binary ‘blobs’ (binary large object—arbitrary size binary data);
   Ends of pipes
   Other Bundles
Duplicates allowed: more than 1 item can exist in the bundle with the same name.
Ordered: order in which name/value pairs are added is preserved and hence allows one to specify a required instance of a duplicate (e.g. the first or the second with the same name).

Bundles cannot be sent down pipes unmodified since they are structured data and pipes only transmit raw binary data; hence, bundles need to be converted into a sequence of bytes (e.g. XML file or binary encoding) that can be sent down a pipe and be re-converted into a bundle at the other end. Likewise, a bundle can be converted/serialised to XML using some glue logic and then sent to a legacy component (or something outside of mStream) that can only read XML.

Also, pipe ends can be added as values in a bundle (e.g. the end-point of a pipe could be defined in a bundle). Having objects like a pipe end in a bundle may mean that some kinds of glue logic cannot be used to save or serialise them.

Tasks/“Pipe Processors”

Tasks are units of code that manipulate pipes and bundles. mStream defines APIs that specify that how these units of code must be written and must be invoked. It is the highest level abstraction of an operation (inevitably an operation on pipes and/or bundles).

Summary of Mandatory Properties:

Code that does processing: e.g. a DLL (a dynamic linked library—code that is invoked by calling a known function), script (a text file that is interpreted at run time by some other code and which allows the developer to alter the script file) or executable (stand alone compiled code that runs in its own process space).
Tasks have a name and hence instances can be created by specifying that name.
Non running: when tasks are created they are initially non-running (i.e asleep or suspended).
Instances of tasks are created by specifying the following:
   Name of the task to be invoked;
   Command line (optional): a text string that contains optional start up parameters
   The ‘read’ ends of 2 pipes to be passed to it (optional—could pass 0, 1 or 2 read ends));
   The ‘write’ ends of 2 pipes to be passed to it (optional—could pass 0, 1 or 2 write ends);
   A bundle from which they can read values—an Input bundle (optional);
   A bundle to which they can write anything they need—a result bundle placeholder (optional);
Startable: once created, can be started.
   Notification of actual starting is provided to the ‘owner’ or creator
Can stop itself with ‘return code’
   ‘Owner’ can be notified of finishing and return code

In addition to the three core primitives, there is a manager process that:
Creates and owns the objects
Shares and provides access control for these objects
Starts, owns and monitors the tasks
   Task/Pipe Processor Implementations
Conceptually can be c++, script, cgi, java etc.
Conceptually 2 parts to an implementation:
   An ‘Instance’ of a task that is operating on some items
      Several instances may run simultaneously with a different set of items
      Instances may run in the same/different thread/process
      When an Instance is finished the associated task is completed with a result code
   A single ‘Group’/factory object for each named processor that
      Retrieves the details of the ‘next’ task to perform
      Uses an instance to perform that task
Comparable with factory type architectures such as:
   standard EPOC Server/Session architecture
   COM/OLE class factories
   MDI user interfaces
      Object Life Cycle
Objects are created
   Inside mStream Manager Process
   At the request of ‘client sessions’
   Associated with a 32 bit handle
Inside mStream each client session has
   A unique 32 bit identifier
   A list of objects that the session is using
When a client session is finished with an object it ‘Releases’ the handle
   When an object is not being used, it is deleted
   Whenever a session ends, the manager releases all its objects
      Object Sharing and Access Control
Sessions ‘use’ objects by requesting that the manager performs operations on objects associated with ‘handles’
Manager keeps list of ‘used/owned/known’ handles for all sessions
   Operations only allowed on objects in a sessions ‘used’ list
   Allowed operations specified for each handle in this list
Restricted methods to add objects into list
   Create the objects
   Receive a handle as a result of another mStream operation
   By another session explicitly sharing it with a request to the manager
      The first session may only share objects for which it has the ‘can_share’ permission.
      The first session can only grant permissions it has itself already
      The first session specifies the id of the session to share to
      The first session is responsible for choice of which session to trust/share too
         Unicode

Streams and pipes deal with binary data. Narrow text can therefore be easily transmitted since text is 8 bit. Unicode text however can be 2 or 4 byte wide and so there are issues of casting data to bytes pointers and also of byte ordering. Also in some cases the data will be from the western character set i.e. HTTP requests, etc. Taking this into account, the examples and helper DLLs that are part of mStream Symbian implementations convert Unicode data (usc2) to UTF8 when writing data to a pipe and convert back from UTF8 to UCS2 when reading from a pipe. This is not compulsory and pipe processor authors are entirely allowed to use whatever encoding they wish to use. Provided both ends of the pipe are using the same encoding there will be no problem. mStream converts between UTF8 and UCS 2 strings and treats equivalent encodings as equivalent strings.

Service Frameworks

Since bundles can express complex structured data they can be used to model service request messages and response messages. These messages can be encoded by glue logic and transmitted down a pipe to another processor that delivers them to the target processor. This same glue logic can be used to encode bundles so that they can be persisted to file or even printed to paper in a human readable form. The chosen encodings can be standards based such as XML or proprietary. The bundle, which represents the message, can include sub messages and routing information. The visibility and editability of these sub bundles and values can be limited by the framework so that some messages are read only while others may be modifiable. The framework may also be used to provide credential information as to the originator of a bundle.

Pipe Processor Example Uses

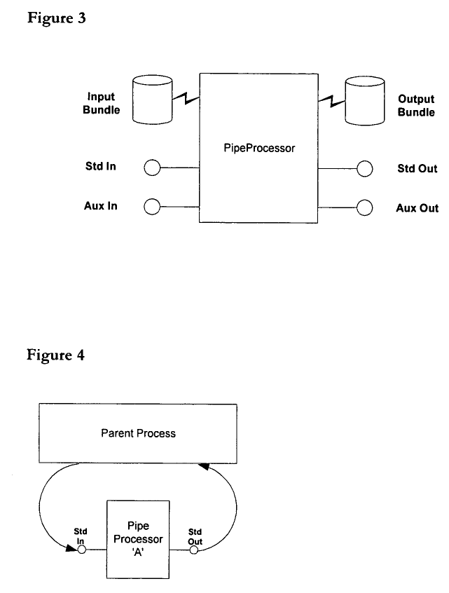

What the pipe processor does with its input data (commandline streams and bundle) and what it produces as its output (stream and/or bundle) is entirely up to the developer of the pipe processor. Pipe processors do not need to use all input output streams of bundles. For example a pipe processor may only deal with its standard input and output streams. Such a pipe processor could be used as a filter or a request/response processor. A Pipe Processor might only manipulate its input and output bundles and could be used to perform RPC calls. A logical diagram of a Pipe Processor is given below at FIG. 3.

mStream can handle an arbitrary number of pipe processors and so they can be used in a variety of ways. At the simplest level an application could invoke a pipe processor to do some work, pass it some data via the pipe connected to its standard input (stdin) and collect the data it generated at its standard output pipe (stdout), as shown in FIG. 4.

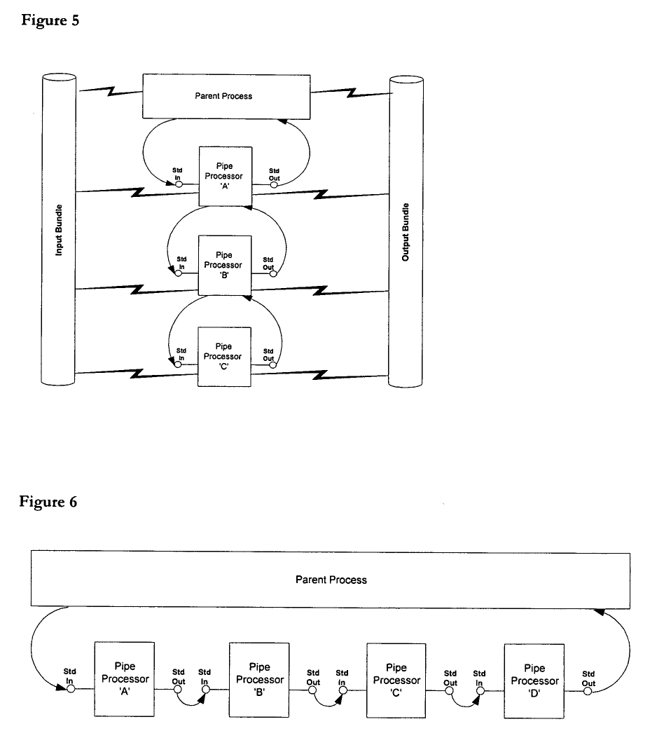

More complex schemes might use the pipe processor, further delegating work to a pipe processor which could in turn delegate work to another and so on. This is shown in FIG. 5; note that in this example all the modules have been set up to share bundles.

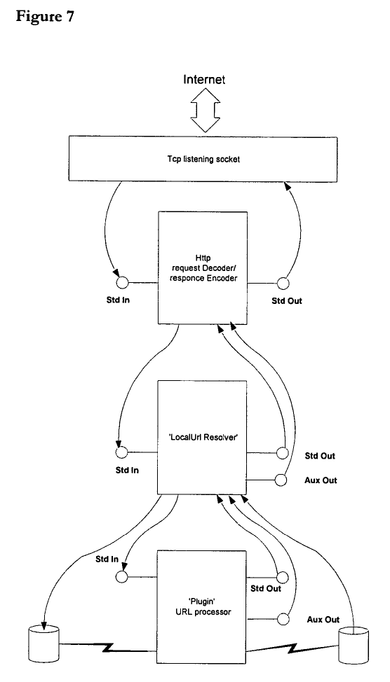

An alternative configuration might be as a pipeline where subsequent processors filter or transform the data produced by the previous processor in the pipeline, as shown in FIG. 6.

Such a structures could be used to construct a web server with a plug architecture, as shown in FIG. 7. The plugins are pipe processors that where necessary read posted data or produced HTML or jpg or other content dependant on the URL. The URL could be specified both as the command line to the pipe processor and as values in an input bundle passed to the plug-in.

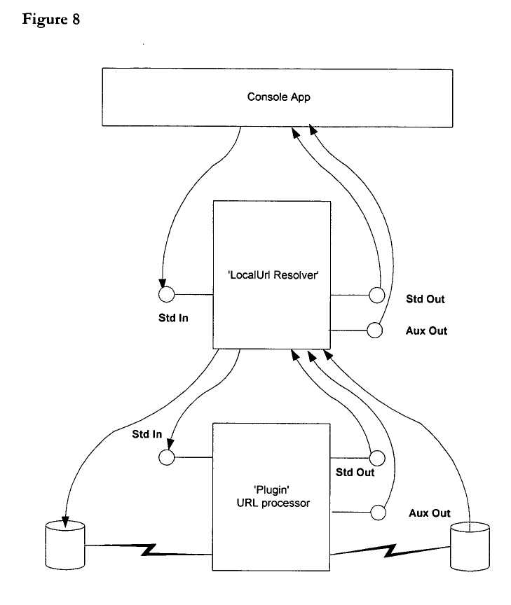

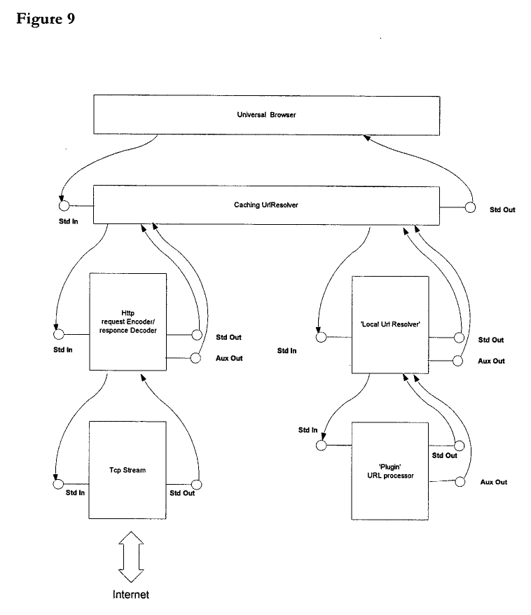

Such a scheme has the advantage that the plugins can be tested individually via a console (i.e. the console app) as shown in FIG. 8. The same components could be used as part of a smart browser that understood the difference between local hosted data and remote data that needed a HTTP request generated to fetch it, as shown in FIG. 9.

mStream Implementation Details—Core Modules

mStreamMan is a library that provides several objects that can be used as building blocks for multipart systems. It does not dictates any particular architecture and supports both asynchronous active objects and synchronous blocking thread execution. It supports Symbian's eStdLib and through the use of out of process executables enables the compilation (with minimal changes) and use of standard C/C++ code that uses stdio streams.

The mStream implementation consists of the following core modules:

MStreamMan—This is a ‘server’ process that manages all the mStream objects in its process space. It also includes a set of functions that clients can use to request operations from the process manager. This set of functions is platform neutral, such that systems developed using it are trivially recompiled on other operating systems.

MStreamClient—This is a lib/DLL that clients of mStream use to request operations from the manager process. The API presented uses standard Symbian parameters such as descriptors and active objects. While such code is then harder to port than a platform neutral API it is more familiar to implement for Symbian based developers.

MStreamLegacy—This DLL provides a set of base classes that developers can use as the basis for writing pipe processors as polymorphic DLLs.

MStreamExe—this DLL provides a set of utility classes that developers can use to write pipe processors as separate processes/executables.

MStreamStdLib—this lib wraps the mStream APIs such that they appear as a standard C i/o lib. Pipes are mapped to standard input/output streams and bundles are represented as environments that can be accessed using conventional getenvo, putenv functions. This module is intended for use with eStdLib to provide a simple way to compile existing standard C++/C code as tasks.

There are other DLLs/modules that Intuwave provide that build on the core mStream APIs and facilities.

MStreamObjects—This DLL wraps the mStream client API as a set of classes that simulate message passing and provides a service framework. Using this DLL developers can write ‘web services’ that are in reality pipe processors.

MStreamShell—this pipe processor can act as a simple command line processor. It can read its input stream and parse and perform a limited number of operations. The most useful of these is to invoke other pipe processors passing in user specified arguments and optionally redirecting input/output from these child processors from/to files or too other processors. This pipe processor can also parse its commands from a file and as such can be used to process scripts.

MConsole is a simple console type application. It allows the user to type input in using the keyboard/keypad and sends those characters to a selected pipe processor. The pipe processor then returns characters via its output pipe, which the console app captures and redirects, to the screen. This usage pattern is treating tasks as comment line interpreters. It is obvious that not all tasks will read/write human readable content, and thus only some tasks may actually be used in this fashion.

MStreamScript is a DLL that allows the invocations scripts as pipe processors. It does this by identifying the script language of a named script and the pipe processor that interprets that language. The identified processor then gets invoked and passed the original script. The client however is only aware that they have invoked a task using the name of the original script file. The client need not be aware that it is actually another processor interpreting a specific script.

TcpListener is a re-usable component that is configured to listen on a number of TCP ports for incoming network connections. As such connections are created, their input and output is redirected at a new instance of a pre-configured processor. The processor itself need not know that it is receiving its input from TCP. TcpListener passes some information about the connection to the processor in its input bundle should it optionally wish to use the information. TcpListener is not itself a pipe processor; this is an implementation choice rather than a necessity.

MStreamTcp is a pipe processor that can be used to connect to a specified TCP port and address. It performs a similar role to tcplistener except a) it is for outgoing rather than incoming connections and b) it does not itself create tasks but is pre-created with input/output pipes possibly already attached to another task. Note that mStreamTcp does not know which processor is connected to its i/o pipes it merely acts as a relay between that piped data and the TCP stream it has been asked to initiate.

MStreamEcho is a pipe processor that reads from its input pipe(s) and writes the same data to its output pipe(s), i.e. it echoes back whatever it is sent. Its typical role is as part of testing, i.e. the test sends some data through a pipeline to mStreamEcho and then receives the data back. Given the intended behaviour of the pipeline the return data will be of an expected format (usually the same as originally transmitted) the return data can be validated and thus the validity of the tasks in the pipeline can also be inferred.

Examples Source Code Using TcpListener, mStreamTcp and mStreamEcho

```
#define TCPSERVICE _L(“mStreamTcp”)
#define ECHOSERVICE _L(“mStreamEcho”)
#define ECHOPORT 5000
void TestBasicTcpFunctionalityL(TInt /*n*/)
    {
    //register listener
    EnableTcpListenerL(ETrue);
    RmStream m;
    TRequestStatus status;
    m.ConnectL( );
    //create writer
    mStream::TPipeItem toTcp=m.CreatePipeL( );
    mStream::TPipeItem fromTcp=m.CreatePipeL( );
    mStream::TBundleHandle parameters=m.CreateBundleL( );
    m.AddBundleItemL(parameters,_L(“DestinationAddress”),_L(“
127.0.0.1”));
    TBuf<16> port;
    port.Format(_L(“%d”),ECHOPORT);
    m.AddBundleItemL(parameters,_L(“DestinationPort”),port);
    mStream::TTaskHandle
task=m.CreateTaskL(TCPSERVICE,_L(“”),
    toTcp.iReader,fromTcp.iWriter,NULL,NULL,parameters,NULL);
    m.StartTask(task,status);
    User::WaitForRequest(status);
    User::LeaveIfError(status.Int( ));
    //release the end of the pipe we dont want/need any more
    m.ReleaseItems(&toTcp.iReader);
    m.ReleaseItems(&fromTcp.iWriter);
    //pipe data into writer and close
    m.WritePipe(toTcp.iWriter,_L8(“Hello
World”),status,mStream::EAppendEof);
    User::WaitForRequest(status);
    User::LeaveIfError(status.Int( ));
    //read data from reader and check for close
    TBuf8<64> buffer;
    m.ReadPipe(fromTcp.iReader,&buffer,status);
    //will try and read 64 bytes ... (except pipe is shorter)
    User::WaitForRequest(status);
    User::LeaveIfError(status.Int( ));
    //ok try again - this time should get eof
    m.ReadPipe(fromTcp.iReader,&buffer,status);
    User::WaitForRequest(status);
    if(status.Int( )!=KErrEof)
        User::LeaveIfError(status.Int( ));
    //wait for writer process to exit
    mStream::TResultBuf result;
    m.WaitForTaskCompletion(task,&result,status);
    User::WaitForRequest(status);
    User::LeaveIfError(status.Int( ));
    //release the bits we dont want/need any more
    //(actualy gets done for us anyways by the close)
    m.ReleaseItems(&toTcp.iWriter);
    m.ReleaseItems(&fromTcp.iReader);
    m.ReleaseItems(&parameters);
    m.ReleaseItems(&task);
    m.Close( );
    //unregister listener
    EnableTcpListenerL(EFalse);
    }
```

Examples of Different Programs Using mStream
MSurf

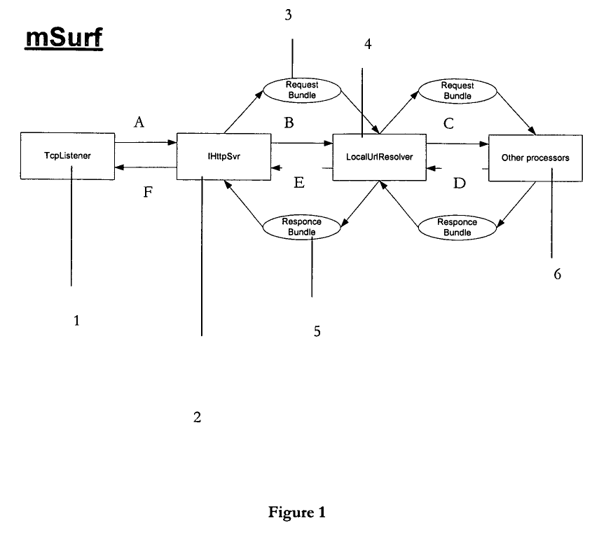

MSurf (see FIG. 1) is a web server implementation for a mobile computing device (see for example PCT/GB02/003915) by Intuwave Ltd for the Symbian platform. It is based on mStream. mStream was in fact created through the identification of recurring patterns within the mSurf implementation. The mSurf web server splits the action of servicing a web request into a pipeline of much simpler modules. The first is TcpListener 1 which listens for incoming TCP connections typically on port 80. This module converts the TCP data stream into a pair of pipes A and F that are passed in and out of a selected module. In this case the second module is a pipe processor called IhttpSvr 2. This pipe processor reads the input data stream and parses the HTTP request headers and content. It creates a bundle 3 that corresponds to the request header and a pipe B that corresponds to the decoded content. Both are then passed to a third pipe processor called LocalUrlResolver 4, which is responsible for populating a response bundle and response pipe C. The response is converted by iHttpSvr 2 back into a HTTP formatted response which is sent back by a pipe to the first module TcpListener 1 and back to the original requester. The already mentioned LocalUrlResolver 4 processor itself uses other pipe processors 6 to service the request.

Note that another module that listened using secure sockets could replace the first module 1, or one which retrieved its requests from a file or other source. Such a replacement would not affect the rest of the pipeline. Also note that a processor that serviced WAP or Obex requests could replace the second module, as explained earlier. Finally the third module that resolves requests locally could be replaced with another module that uses different rules. Each of these modules could be used or combined to form other systems.

The IHttpSvr 2 module could be combined with a module that performs multiplexing and is used to create an HTTP based VPN solution capable of tunnelling through some firewalls. The TcpListener 1 module has been reused as shown in the following examples.

Example—mView

mView is a system that allows a desktop user to control a Symbian device. A processor exists on the mobile computing device that captures the image on the screen and compresses it. Remote desktop users can then connect to this mViewEngine processor and retrieve these compressed snapshots for display on the desktop computer. Likewise the desktop application can send keyboard and mouse/pen movements to the mViewEngine processor that are then treated as though the mobile device user had pressed those keys on the real device. This remote control behaviour is simple but the implementation as a task enables a range of use cases for how the desktop and mobile devices are connected.

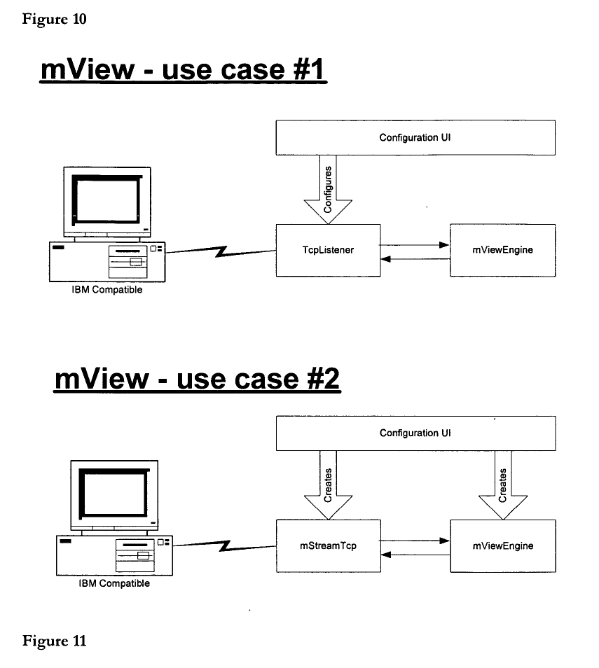

In one configuration the PC can connect to TcpListener on the device, which then forwards data as usual via pipes to the mViewEngine processor as shown in FIG. 10. In another configuration, shown in FIG. 11, the device can create an outgoing connection to the desktop using mStreamTcp and then join this to the input/output pipes of an instance of a mViewEngine processor. In another configuration the desktop and device can both connect to a relay station. The setup code on the device can launch mStreamTcp communicate with the relay node and then once done pass the appropriate pipes to the mViewEngine. The functionality of the engine remains unchanged despite the network topology used to connect the devices.

Example—Symbian Connect

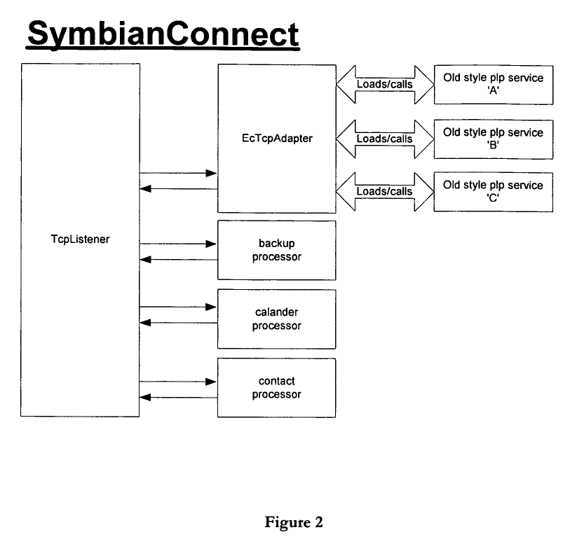

With Symbian connect, as shown in FIG. 2, the TcpListener module is used to listen on several TCP ports each connected to a service for use by a Desktop PC. Standard Symbian components are used to create a PPP connection. The Desktop PC then connects to the services it wishes to use and then communicates with those services by reading/writing service specific packets of binary data. One of these pipe processors EcTcpAdapter converts these packets of data into requests that are then passed on to legacy connectivity services that were written for another protocol stack called PPP. This translation from one encoding sent through a pipe to another format is an example of how processors can be used as adapters to older legacy code. There is nothing to prevent these same services being exposed through a secure sockets layer or even through an http tunnel. The processors providing service layer functionality make no assumption about the networking layer.

Example—Multiplexor

The design of processors as already stated includes the concept of a group and the concept of an instance. Either of these 2 parts of a processor can own resources. Several instances can exists simultaneously and can each be communicating using separate pipes to other modules and tasks. Since each of the instances can typically access the group (being part of the same processor implementation) they are able to share the resources of the ‘group’ object. The sharing of these resources is co-operative, the exact details depending on the implementation. Some instances may get highest priority access to the resources or alternatively each instance may get a time slot in which it has exclusive access. These ‘group’ object resources may include other pipe ends being used to communicate with other modules. The content of the pipes used by the ‘instances’ can thus be multiplexed down one or more other pipe ends that are owned by the group. Return data can be de-multiplexed in a similar manner. Such an implementation can be used to reuse network connections that are resource expensive to establish but cheap to use. When combined with an HTTP server or HTTP client module, together with TcpListener 1 it is possible to create a VPN type solution that could tunnel through a firewall on port 80. Note that such a solution could be easily modified to use alternative encodings of frames and the use of HTTP could be switched for another bearer without affecting the rest of the system.

1. A method of developing a software program for resource constrained mobile computing devices, comprising the step of using a library of three types of code which enable a system to be modelled, the three types of code being:
(a) a first re-useable object which defines the transmission of raw binary data between 2 ends;
(b) a second re-useable object which defines ordered name/value pairs; and
(c) an abstract API definition that defines how to write, create, call or use a task which handles the first and/or second objects;
characterised in that these three types of code form a restricted set of mandatory primitives that are re-used by one or more applications running on the device.

2. The method of claim 1 in which some or all of the three mandatory types of code are re-useable to enable different programs to be rapidly developed.

3. The method of claim 1 in which the re-useable objects and the task are burnt to ROM in the mobile computing device.

4. The method of claim 3 in which a program requires additional code to accomplish a defined task and that additional code is implemented as a re-useable task, and is burnt to ROM or runs in RAM.

5. The method of claim 1 in which a task makes a decision as to which other tasks it needs to call at run time.

6. The method of claim 5 in which the other tasks are added to the device after initial shipment.

7. The method of claim 1 in which the first object is implemented as a pipe with the following properties:
(a) Uni directional;
(b) Inter-process/inter-thread capability;
(c) Buffered;
(d) Handles binary data and is content/format unaware;
(e) Handles infinite or finite content length.

8. The method of claim 1 in which the second object is implemented as a bundle with the following properties:
(a) Contains name/value pairs;
(b) Names are case sensitive;
(c) Values include: Strings, binary ‘blobs’, ends of pipes and other bundles
(d) Duplicates allowed;
(e) Ordered.

9. The method of claim 1 in which tasks are defined by the API as having the following properties:
(a) Has a name and hence instances can be created by specifying that name;
(b) Are non running when first created;
(c) Instances of tasks are created by specifying the name of the task to be invoked;
(d) Are startable once created;
(e) Notification of actual starting is provided;
(f) Can stop itself with ‘return code’;
(g) ‘Owner’ can be notified of finishing and return code.

10. The method of claim 1 comprising the step of using a manager process that creates and owns the first and second objects and starts and owns the tasks.

11. The method of claim 1 in which there is a manager process that creates or controls the objects and the tasks.

12. The method of claim 11 in which the manager process allows client sessions to request access to an object.

13. The method of claim 12 in which the manager process enforces entitlement to access an object.

14. The method of claim 13 in which client sessions request the manager process to change the entitlement of a further client session to access an object.

15. The method of claim 12 in which the manager process exposes the object externally with a handle.

16. Computer software adapted to run on a mobile computing device when programmed with a runtime library comprising three types of code which enable a system to be modelled, the three types of code being:
(a) a first re-useable object which defines the transmission of raw binary data between 2 ends;
(b) a second re-useable object which defines ordered name/value pairs and
(c) an abstract API definition that defines how to write, create, call or use a task which handles the first and/or second objects;
characterised in that the software uses the three types of code programmed on the device as a restricted set of mandatory primitives.

17. The computer software of claim 16 that requires additional code to accomplish a defined task and that additional code is implemented as a re-useable task, and is burnt to ROM or runs in RAM.

18. The software of Clam 16 programmed so that a task makes a decision as to which other tasks it needs to call at run time.

19. The computer software of claim 16 that defines new tasks and the software is loaded onto the device after initial shipment of the device.

20. The computer software of claim 16 in which the first object is implemented as a pipe with the following properties:
(a) Uni directional;
(b) Inter-process/inter-thread capability;
(c) Buffered;
(d) Handles binary data and is content/format unaware;
(e) Handles infinite or finite content length.

21. The computer software of claim 16 in which the second object is implemented as a bundle with the following properties:
(a) Contains name/value pairs;
(b) Names are case sensitive;
(c) Values include: Strings, binary ‘blobs’, ends of pipes and other bundles
(d) Duplicates allowed;
(e) Ordered.

22. The computer software of claim 16 in which tasks are defined by the API as having the following properties:
(a) Has a name and hence instances can be created by specifying that name;
(b) Are non running when first created;
(c) Instances of tasks are created by specifying the name of the task to be invoked;
(d) Are startable once created;
(e) Notification of actual starting is provided;
(f) Can stop itself with ‘return code’;
(g) ‘Owner’ can be notified of finishing and return code.

23. The computer software of claim 16 comprising a manager process that creates and owns the first and second objects and starts and owns the tasks.

24. The computer software of claim 16 comprising a manager process that creates or controls the objects and the tasks.

25. The computer software of claim 24 in which the manager process allows client sessions to request access to an object.

26. The computer software of claim 25 in which the manager process enforces entitlement to access an object.

27. The computer software of claim 26 in which client sessions request the manager process to change the entitlement of a further client session to access an object.

28. The computer software of claim 26 in which the manager process exposes the object externally with a handle.

29. A mobile computing device when programmed with a runtime library comprising three types of code which enable a system to be modelled, the three types of code being:
(a) a first re-useable object which defines the transmission of raw binary data between 2 ends;
(b) a second re-useable object which defines ordered name/value pairs and
(c) an abstract API definition that defines how to write, create, call or use a task which handles the first and/or second objects;
characterised in that these three types of code form a restricted set of mandatory primitives that are re-used by one or more applications running on the device.

30. The device of claim 29 in which the or each application combines the mandatory primitives with additional logic.

31. The device of claim 29 in which the re-useable objects and the task are burnt to ROM in the mobile computing device.

32. The device of claim 31 in which the or each application requires additional code to accomplish a defined task and that additional code is implemented as a re-useable task, and is burnt to ROM or runs in RAM.

33. The device of claim 29 programmed so that a task makes a decision as to which other tasks it needs to call at run time.

34. The device of claim 33 in which the other tasks are added to the device after initial shipment.

35. The device of claim 29 in which the first object is implemented as a pipe with the following properties:
(a) Uni directional;
(b) Inter-process/inter-thread capability;
(c) Buffered;
(d) Handles binary data and is content/format unaware;
(e) Handles infinite or finite content length.

36. The device of claim 29 in which the second object is implemented as a bundle with the following properties:
(a) Contains name/value pairs;
(b) Names are case sensitive;
(c) Values include: Strings, binary ‘blobs’, ends of pipes and other bundles
(d) Duplicates allowed;
(e) Ordered.

37. The device of claim 29 in which tasks are defined by the API as having the following properties:
(a) Has a name and hence instances can be created by specifying that name;
(b) Are non running when first created;
(c) Instances of tasks are created by specifying the name of the task to be invoked;
(d) Are startable once created;
(e) Notification of actual starting is provided;
(f) Can stop itself with ‘return code’;
(g) ‘Owner’ can be notified of finishing and return code.

38. The device of claim 29 comprising a manager process that creates and owns the first and second objects and starts and owns the tasks.

39. The device of claim 29 comprising a manager process that creates or controls the objects and the tasks.

40. The device of claim 39 in which the manager process allows client sessions to request access to an object.

41. The device of claim 40 in which the manager process enforces entitlement to access an object.

42. The device of claim 41 in which client sessions request the manager process to change the entitlement of a further client session to access an object.

43. The device of claim 40 in which the manager process exposes the object externally with a handle.
